(19) United States
(12) Patent Application Publication
(10) Pub. No.: US 2011/0184870 A1
(43) Pub. Date: Jul. 28, 2011

(54) FORM PROCESSING IN A USER INTERFACE WORKFLOW COMPOSITION TOOL

(75) Inventors: Mark Angel, Sunnyvale, CA (US); Rob Arsenault, Bedford, NH (US); Kannan Chellappa, Sunnyvale, CA (US); Max Copperman, Sunnyvale, CA (US); Kendall Herrick, Bedford, NH (US); Randall McRee, Sunnyvale, CA (US); Hector Torres, Bedford, NH (US)

(73) Assignee: KANA SOFTWARE, INC., Sunnyvale, CA (US)

(21) Appl. No.: 13/080,632

(22) Filed: Apr. 5, 2011

Related U.S. Application Data
(63) Continuation-in-part of application No. 12/603,524, filed on Oct. 21, 2009.

(51) Int. Cl. G06Q 10/00; G06F 3/048; G06F 17/30

(52) U.S. Cl. 705/301; 715/771; 707/741; 707/758; 707/E17.049; 707/E17.014

(57) ABSTRACT

A method for user interface workflow composition includes defining a form of different fields, at least one of the fields in the form referencing a business object providing access to data in an external data source that is different than at least one other data source for a correspondingly different one of the fields. A set of references to both human steps and automated steps of a workflow is loaded such, each human step referencing a corresponding user interface and each human step and automated step individually including contextual data. A human step is generated for the defined form and loading into the module. Graphical elements, each representative of a selected human or automated step, are visually placed into a canvas along with an individual graphical element representative of the defined form. Transitions are defined between the human and automated steps represented by corresponding graphical elements setting forth a user interface workflow. Finally, computer readable instructions are generated for the user interface workflow.

### CROSS-REFERENCE TO RELATED APPLICATIONS

This patent application claims the benefit under 35 U.S.C. §120 as a continuation-in-part of presently pending U.S. patent application Ser. No. 12/603,524, entitled USER INTERFACE WORKFLOW COMPOSITION METHOD, SYSTEM AND COMPUTER PROGRAM PRODUCT, filed on Oct. 21, 2009, the entire teachings of which are incorporated herein by reference

### BACKGROUND OF THE INVENTION

1. Field of the Invention

The present invention relates to the field of business process modeling (BPM) and more particularly to workflow composition for business process modeling.

2. Description of the Related Art

Process modeling relates to the modeling of dynamic or static systems, which can include, but are not limited to, enterprise management systems, customer relationship management (CRM) systems, engineering systems, networked information technology systems, utility systems, utility computing systems, autonomic computing systems, on-demand systems, electric power grids, biological systems, medical systems, weather systems, financial market systems, and business process systems. Such systems can be modeled and simulated for a variety of purposes including monitoring, analysis, control, design, simulation, and management.

A process model is an abstract description of a process such as a business process or any other process related to the lifecycle of a system. The abstract description of the process model can include sufficient detail required by a simulation engine for exercising the process model with one or more scenarios to determine a likely outcome. Process models generally specify one or more steps or activities of a process and the relationship between the different steps or activities. As part of the model, one or more events or conditions leading to the transition from one step or activity to the next can be specified so as to define a workflow. Models defining a workflow generally are expressed according to a specific format. Exemplary formats include Activity Decision Flow (ADF) Unified Modeling Language (UML) activity diagrams, and the Business Process Execution Language (BPEL), to name only a few.

Workflows created in a BPM environment can be deployed for execution and execution lifecycle management in a Web services architecture. As it is well-known in the art, generally, a workflow process execution engine accepts as input a workflow such as that specified in BPEL, and produces one or more executable instances of components requisite to the workflow. Thereafter, the executable instances can be deployed in a network accessible architecture such that end users can access the workflow remotely from over a computer communications network.

Workflows have proven particularly effective in CRM applications. Generally, a workflow for a CRM application can specify a series of steps or activities to be performed either automatically (computer steps) or by a person (human steps) and can include by way of example, a step for retrieving a customer record, a step scripting a dialog with a customer, or a step for sending a responsive message to a customer inquiry. Transitions between steps can be governed by rules and workflows can be triggered by events. Notwithstanding, defining the workflows including triggering events, steps and transitions can be tedious for the uninitiated. Consequently, several workflow design tools provide for the graphical expression of workflows in order to ease the process of designing workflows.

By way of example, conventional workflow design tools for CRM provide a graphical user interface through which a business analyst can specify a flow steps to be performed by an end user in providing CRM services. Sophisticated workflow design tools provide a further capability of a drag and drop interface for defining a workflow by dragging and dropping steps from a listing of available steps onto a palette. The drag and drop nature of the conventional workflow design tool acts to minimize the necessity of software development expertise in composing a workflow for CRM. Even still, conventional workflow design tools for CRM lack a close coupling to the nature of CRM workflow and leave much omitted requiring technical intervention by a software developer. Examples include generating different screens for different steps in a workflow, determining the exchange of contextual data between steps in a workflow and determining and policing service level objectives for different steps in a workflow. Indeed, the user interface of the conventional workflow design tool leaves much to be desired in terms of convenience and simplicity.

### BRIEF SUMMARY OF THE INVENTION

Embodiments of the present invention address deficiencies of the art in respect to workflow design tools and provide a novel and non-obvious method, system and computer program product for user interface workflow composition. A method for user interface workflow composition can include defining a form of different fields. At least one of the fields in the form can referenced a business object providing access to data in an external data source that is different than at least one other data source for a correspondingly different one of the fields. The method also can include loading into a composition module a set of references to both human steps of a workflow and also automated steps of a workflow. Each of the human steps of the workflow can reference a corresponding user interface and each of the human steps and automated steps of the workflow individually can include contextual data.

The method also can include generating a human step for the defined form and loading the generated human step for the defined form into the composition module. Thereafter, individual graphical elements can be visually placed into a canvas rendered by the composition module. Each individual graphical element can be representative of a selected one of the human steps and automated steps. Further, an individual graphical element representative of the defined form can be visually placed into the canvas. Transitions can be defined between different ones of the human steps and automated steps represented by corresponding ones of the graphical elements in the canvas by creating visual connections between the different ones of the graphical elements in the canvas. In this regard, the human steps and automated steps can be represented by the graphical elements in the canvas, and the transitions defined therebetween can set forth a user interface workflow. Finally, the method can include generating computer readable instructions for the user interface workflow.

Once created, the computer readable instructions can be provided to a workflow engine to generate programmatic objects implementing the user interface workflow including display of an instance of the form, and to execute the programmatic objects for use by end users over a computer communications network. Thereafter, each field of the instance of the defined form can be searched for a matching string without searching a data source for each field in the instance of the defined form. Further, content accessible through each field of the instance of the defined form can be indexed by reference to a corresponding data source external to the instance of the defined form for use in searching the fields of the instance of the defined form without searching each data source for each field in the instance of the defined form.

In an aspect of the embodiment, different fields of the instance of the defined form can be completed by the end user by providing either new or modified data in the different fields. In response, the data provided by the end user can be persisted in correspondingly different external data sources through respective business objects. In this regard, for each field in which data is provided, an update (or create as the case may be) for the data can be directed in an external data source corresponding to the field by way of an intermediate business object referenced by the field. Further, a retrieve can be performed to retrieve for different fields data from corresponding ones of the external data sources. The data retrieved into the fields of the form can be persisted in an index separate from the external data sources. In this way, queries can be processed against the data of the fields in the index and not in the different data sources. As a result, the necessity of joining the different external data sources to conduct a query implicating data in the different external data sources can be obviated by querying only the index.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for user interface workflow composition;

FIG. 2 is a schematic illustration of a workflow composition data processing system configured for user interface workflow composition;

FIG. 3A is a screen shot of a user interface workflow designer in the workflow composition data processing system of FIG. 2 in which different steps and collections of steps can be selected in a palette of the user interface and placed onto a canvas of the user interface;

FIG. 3B is a screen shot of a runtime display for screen design of a collection of forms in a container to be presented in connection with the execution of a human step in the user interface workflow of FIG. 3A;

FIG. 3C is a screen shot of a runtime display for a form design of a form to be presented in connection with the execution of a human step in the user interface workflow of FIG. 3A;

FIG. 4A is a pictorial illustration of a process for forms processing in a workflow composition data processing system of FIG. 2;

FIG. 4B is a flow chart illustrating a process for forms processing in a workflow composition data processing system of FIG. 2; and,

FIG. 5 is a flow chart illustrating a process for user interface workflow composition.

### DETAILED DESCRIPTION OF THE INVENTION

Embodiments of the present invention provide a method, system and computer program product for forms processing in the visual composition of a flow of end user interactions with different steps of a workflow, hereinafter referred to as a user interface workflow. In accordance with an embodiment of the present invention, a user interface workflow composition tool can be provided to facilitate the composition and deployment of a workflow into a computer communications network. The composition tool can provide a unified graphical user interface including a palette in which a listing of references to available steps for inclusion in a user interface workflow can be rendered. Importantly, the steps can include both human steps and automated steps, for example those that pertain to CRM though the invention is in no way limited to the field of CRM.

The unified graphical user interface also can include a portion in which a canvas can be rendered. The canvas can accept the placement of graphical elements corresponding to selected ones of the references to the available steps. The different graphical elements in the canvas can be visually linked to others of the graphical elements so as to represent an ordering of flow from one step to another, the collection of graphical elements in the palette defining a user interface workflow representative of a sequence of user interface screens experienced by an end user when interacting with the workflow. In this regard, the execution of a step in the user interface workflow can result from a transition from one or more other steps and one or more steps can be executed subsequent to the completion of a step. Optionally, any of the graphical elements disposed in the palette can be incorporated within another, different user interface workflow.

A different view can be defined for each one of the human steps. The views can include a display of different user interface controls. Optionally, a view can include a form that includes multiple fields. While a view, for example a form, can be pre-specified for each human step, each view can be modified through the unified graphical user interface. In this regard, additional display controls can be added to a selected view for a human step. An association further can be stored in connection between each view and a corresponding step. Finally, when composing a user interface workflow, a user interface screen for each human step in the canvas can be defined. The screen can include an arrangement of one or more different views for corresponding different human steps.

Of note, at least one of the fields of at least one of the forms can reference a data source that is different from a data source for at least one other of the fields in the form. In this way, the back end data source for each of the fields can be hidden from an end user viewing an instance of the form and the form can behave as an aggregator of data from multiple, different data sources. In an aspect of the foregoing embodiment, content from data sources external to each field in an instance of the form can be indexed. Consequently, searches can be conducted against the fields of the instance of the form without searching content in each of the data sources external to each field. Rather, the index can be consulted during a search of an instance of the form in lieu of searching content in each of the data sources external to each field.

The user interface workflow defined within the canvas of the composition tool can be persisted as artifacts in a database, and subsequently converted into an archive or archives of computer readable instructions suitable for use by a workflow engine. In one aspect of the invention, the user interface workflow can be compiled to BPEL for use as a source document in a workflow engine converting the source document into a series of executable components accessible to end users from over a computer communications network. For example, the components can be placed in container defined within an application server and accessible by way of a services oriented architecture (SOA) provided in a Web services framework.

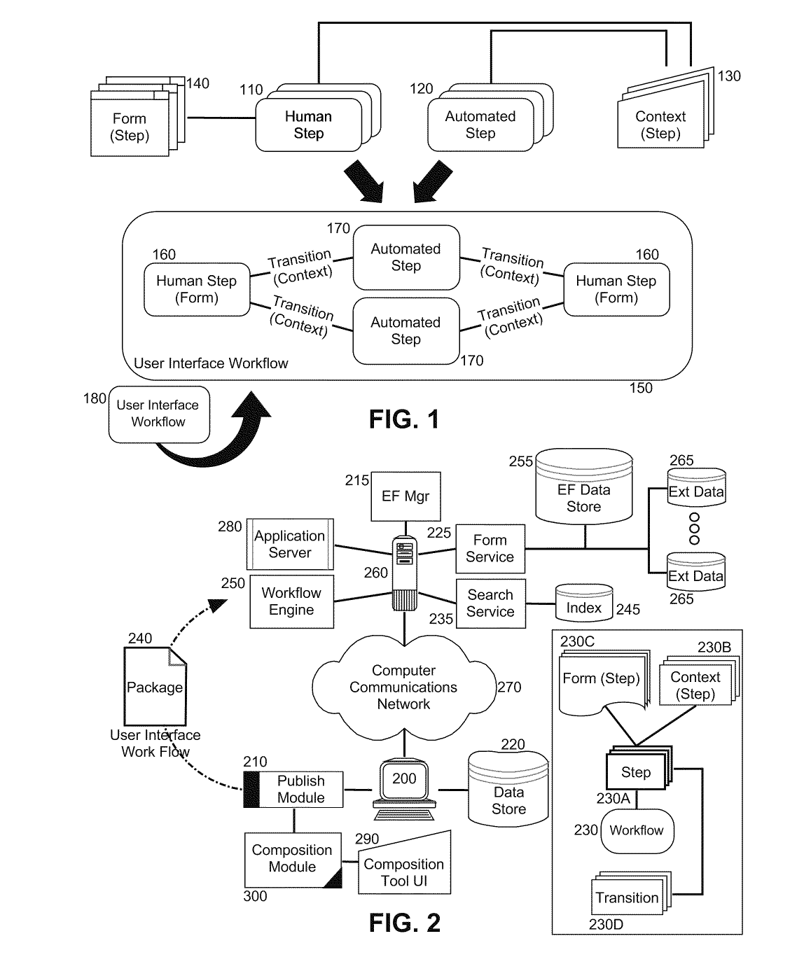

In further illustration, FIG. 1 is a pictorial illustration of a process for user interface workflow composition. As shown in FIG. 1, different steps 110, 120 can be defined for selection and use in a user interface workflow 150. The steps 110, 120 can include both human steps 110, and automated steps 120. Human steps 110 are steps to be performed by a user such as conducting a conversation with a customer, or building a message to be transmitted to a customer. A human step 110 completes when the user indicates that the step is complete through a suitable user interface control disposed in a view of a screen for the human step 110. By comparison, an automated step 120 is a step to be performed programmatically by a computer, such as the retrieval of data and placement of the data in different fields of a form rendered in connection with the automated step 120. Importantly, a user interface view 140—typically a form or collection of user interface controls in a window—for each human step can be specified in connection therewith. As such, referencing a human step 110 necessarily references a corresponding user interface view 140 for the human step 110. Also, both the human steps 110 and the automated steps 120 can be associated with corresponding context 130—specifically data used or produced by an associated step.

Different ones of the steps 110, 120 can be selected for inclusion in the user interface workflow 150. By way of example, as illustrated, human steps 160 and automated steps 170 can be placed in the user interface workflow 150. For each of the human steps 160, one or more views 140 each previously associated with a corresponding one of the steps 160 can be placed in an associated screen. Additionally, a context 130 for each of the steps 160, 170 can be specified including a mapping of a source and/or target for data present in the steps 160, 170. Of note, data mapping can be specified manually by the end user, or data mappings can be determined algorithmically by seeking common data types between steps 110, 120 in the user interface workflow 150. Finally, one or more transitions can be defined for each of the human steps 160 and automated steps 170 indicating upon which condition or conditions a currently focused one of the steps 160, 170 is to end and a next one of the steps 160, 170 is to begin in the user interface workflow 150, and also which next one of the steps 160, 170 is to be invoked upon the ending of a contemporary one of the steps 160, 170.

Of note, the user interface workflow 150 is re-usable once defined such that other user interface workflows 180 can reference the user interface workflow 150 in the same way steps 110, 120 are referenced in the other user interface workflows 180. In this way, robust and unique user interface workflows can be defined over time using existing user interface workflows known to be effective thus obviating the need to invest substantial time and technical resources in developing new user interface workflows. Further, minor modifications requisite to adapting an existing user interface workflow to a new environment need not provoke the completely new specification of a new user interface workflow.

The process described in connection with FIG. 1 can be implemented within a workflow composition data processing system. In further illustration, FIG. 2 is a schematic illustration of a workflow composition data processing system configured for user interface workflow composition. The system can include a computer system 200 with processor and memory configured for communicative coupling to a remote server 260 over computer communications network 270. An operating system can execute in the memory of the computer system 200 to support the operation of a composition module 220 providing composition tool user interface 290.

In this regard, the composition module 220 can include computer program instructions that when loaded into the memory of the computer system 200 and executed by the processor of the computer system 200 can be enabled to load from data store 230 a set of references to different steps 230A for display in a palette of the composition tool user interface 290. The computer program instructions further can be enabled to permit the selection and placement of different ones of the steps 230A onto a canvas of the composition tool user interface 290 each in the form of a graphical representation of a corresponding one of the steps 230A. Yet further, the computer program instructions can be enabled to permit the configuration of a context 230B of contextual data for each of the steps 230A represented by a corresponding graphical element in the canvas, including a type, source and mapping for the contextual data in the context 230B.

Even yet further, the computer program instructions can be enabled to identify different pre-associated views 230C with different ones of the steps 230A represented by a corresponding graphical element in the palette, and also to permit editing of a layout of the different views 230C. Consequently, different ones of the views 230C can be combined into a single screen for presentation in association with a particular one of the steps 230A. Finally, the computer program instructions can be enabled to permit the establishment of one or more transitions 230D between one or more of the steps 230A represented by a corresponding graphical element in the canvas so as to specify under what condition or conditions a contemporary one of the steps 230A has completed and a next one of the steps 230A is to begin.

The aggregation of the steps 230A represented by corresponding graphical elements in the palette of the composition user interface 290, along with the specified contexts 230B, views 230C in different screens, and transitions 230D, can be persisted as a user interface workflow 230—literally, artifacts in the data store 220. Publisher module 210 can compile and publish the artifacts of the workflow 230 into computer readable instructions 240 such as an enterprise archive (EAR) for deployment by a workflow engine 250 executing by an application server 280 in memory by a processor of the remote server 260 for use by different end users over the computer communications network 270.

In particular, a user interface workflow manager 215 can be coupled to the workflow engine 250 in the remote server 260. The user interface workflow manager 215 can process the user interface workflow 230 such that for each selected human step amongst the steps 230C, a corresponding screen can be retrieved and provided a corresponding context 230B. A form service 225 can identify any forms specified for the corresponding screen and retrieve the same for rendering. The fields of each form in the corresponding screen can be generated and linked as set forth in the form to corresponding data sources 255, 265 including both an internal data store 255 and one or more external data sources 265 through representative business objects providing the requisite create, read, update and delete operations. As data is provided in each field of each form, a corresponding index 245 can be updated for all of the data of all of the fields of the form irrespective of a corresponding data source of each field. Subsequently, search operations performed through the search service 235 can be conducted against the index 245.

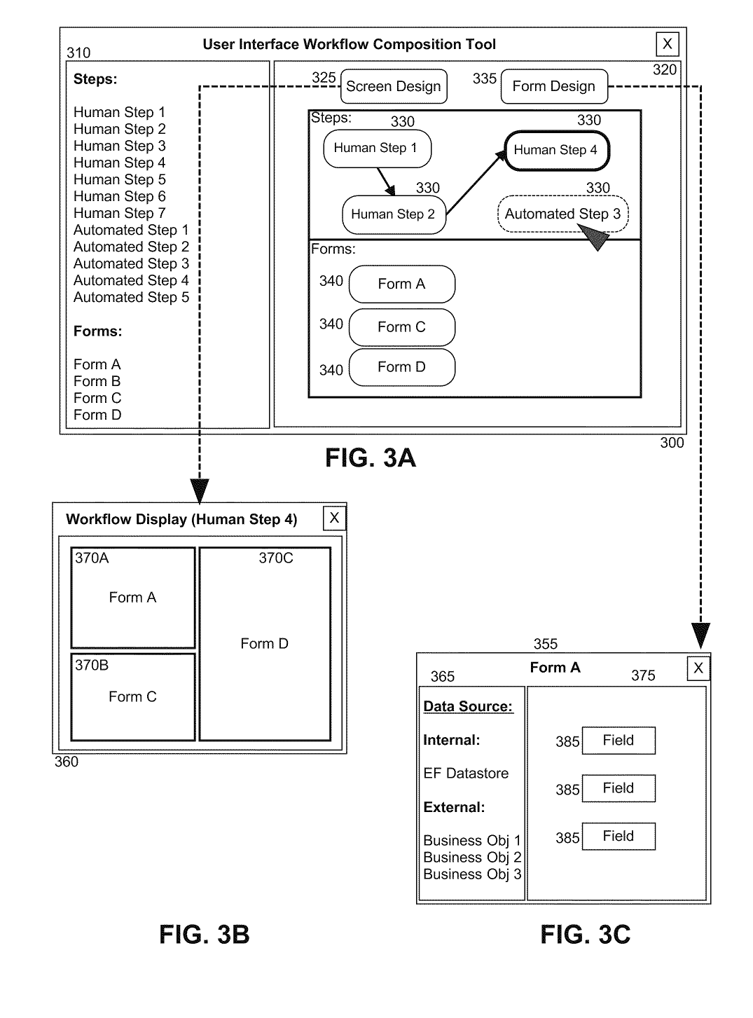

It is to be recognized, then, that integral to the composition of the user interface workflow 240 is the convenience of composition provided by the composition tool user interface 290. As such, in yet further illustration of the composition tool user interface, FIG. 3A is a screen shot of a user interface workflow designer in the workflow composition data processing system of FIG. 2 in which different steps and collections of steps can be selected in a palette of the user interface and placed onto a canvas of the user interface. As shown in FIG. 3A, a user interface workflow composition tool 300 can provide both a palette 310 of available human and automated steps, and also a canvas 320 into which graphical elements 330 representative of selected ones of the steps in the palette 310 can be placed and related to one another through specified transitions so as to define a workflow.

As will be apparent from FIG. 3A, steps can be placed into the canvas individually, or steps can be grouped together as a collection—generally, a sequence of steps 330 to be performed in one sitting by a single person. For each collection, corresponding user interface screens, or forms, can be identified for presentation in conjunction with each corresponding associated step 330 in the collection. Further, additional views 340 such as other forms can be placed into the screen for presentation concurrently with the views for the specified steps 330 aggregated in the collection. Importantly, FIG. 3B is a screen shot of a screen designer 360 invoked through activation of screen design control 325 for the screen of steps 330 aggregated in the user interface workflow of FIG. 3A demonstrating the automated arrangement of views 370A, 370B, 370C corresponding to those views 340. Of note, the views 370A, 370B, 370C can include one or more forms. A form can include multiple different fields with different ones of the fields mapping to different data sources—generally data members of business objects accessible from over a computer communications network. Upon creation or update of a form in a user interface workflow, retrieved values for fields of the form from respective ones of the external data sources can be persisted in an index. Thereafter, a query can be presented in the form and processed not against the external data sources, but against the index. Consequently, access to content in the external data sources can be aggregated seamlessly through the presentation of the form.

Returning now to FIG. 3A, each form amongst the views 370A, 370B, 370C can be separately configured and designed through the activation of form design control 335. Illustration, FIG. 3C is a screen shot of a runtime display for a form design of a form to be presented in connection with the execution of a human step in the user interface workflow of FIG. 3A. As shown in FIG. 3C, a form designer 355 can include a palette 375 into which the control elements such as fields 385 of a form can be placed. Each of the fields 385 can be linked to a data source whether an external data source, or an internal data source through data source control element 365. In this regard, the data source control element 365 can present the different tables of accessible in an internal data source, whereas the data source control element 365 can present a set of known business objects to access data disposed in external data sources.

Upon creation of a form in the form designer 355, a human step can be created in association with the form for placement in the palette 310 of FIG. 3A. Additionally, different automated steps can be created for the form, including an automated step programmed to retrieve data for the fields 365 of the form, an automated step programmed to delete data in the fields 365 of the form from an index and a corresponding external data source (through an intermediary business object, for example) into which the data for the fields 365 of the form had been persisted, an automated step programmed to create a new record in the index and a corresponding external data source with the data in the fields 365 of the form, and an automated step programmed to update a record in the index and a corresponding external data source with data in the fields 365 of the form.

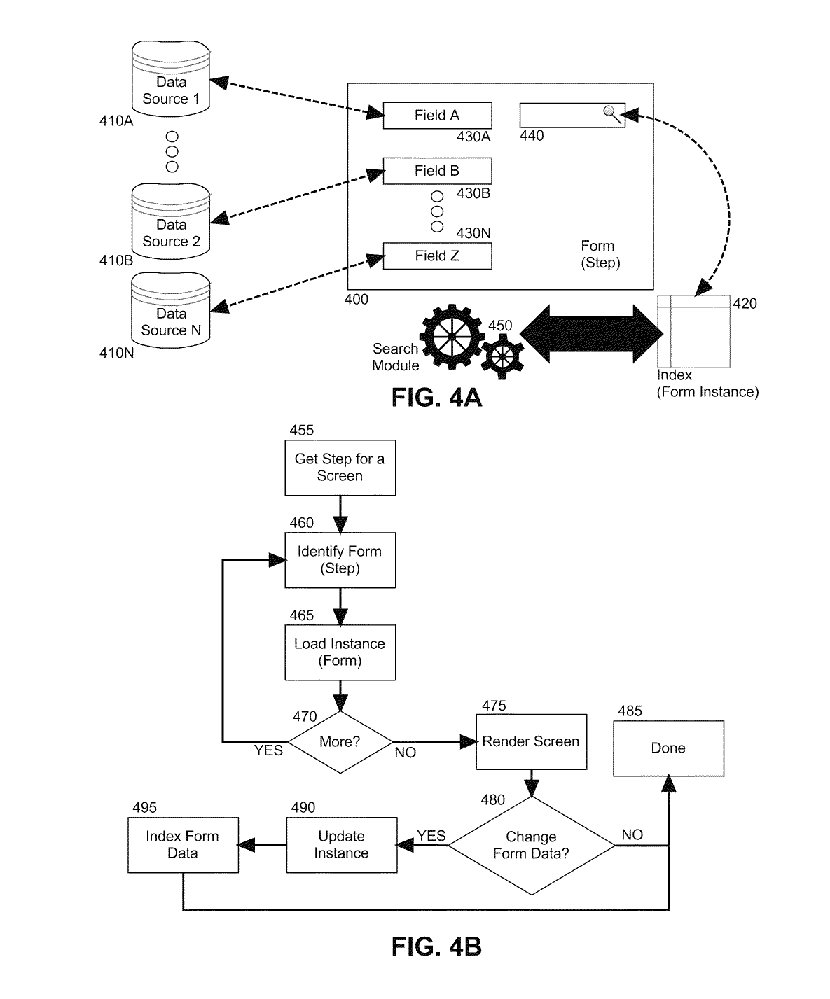

In yet further illustration of the structure of a form for disposal in a screen for a corresponding step of a user interface workflow, illustration, FIG. 4A pictorially shows a process for forms processing in a workflow composition data processing system of FIG. 2. As shown in FIG. 4A, a form instance 400 can include multiple different fields 430A, 430B, 430N. Each of the fields 430A, 430B, 430N can be logically associated by reference to a corresponding data source 410A, 410B, 410N. In this regard, each of the fields 430A, 430B, 430N can be associated by logical reference to one or more data members of an external business object instance. Each of the data members can be processed into an index 420 for the form instance 400. Consequently, a search module 450 accessible through a query field 440 in the form instance can process searches against the external data sources 410A, 410B, 410N by reference to the index 420 rather than by reference to the external data sources 410A, 410B, 410N.

In further illustration, FIG. 4B is a flow chart depicting a process for forms processing in a workflow composition data processing system of FIG. 2. Beginning in block 455, a step in a user interface workflow can be selected for performance and the context of the user interface workflow can be retrieved for a particular screen of the user interface workflow. In block 460, a form corresponding to the step can be determined and in block 465, an instance of the identified form can be loaded and passed the retrieved context. In decision block 470, if additional forms remain to be processed for the step, a next form for the step can be identified in block 460 and loaded in block 465. When no further forms for the step remain to be processed, in block 475, the screen can be rendered in connection with the performance of the selected step. Thereafter, in decision block 480, it can be determined whether or not any data within the form instance has changed. If not, the process can end in block 485. However, if data within the form instance has changed, in block 490 the form instance can be updated to reflect the changed data and in block 495 the data for the form can be indexed to account for the changed data.

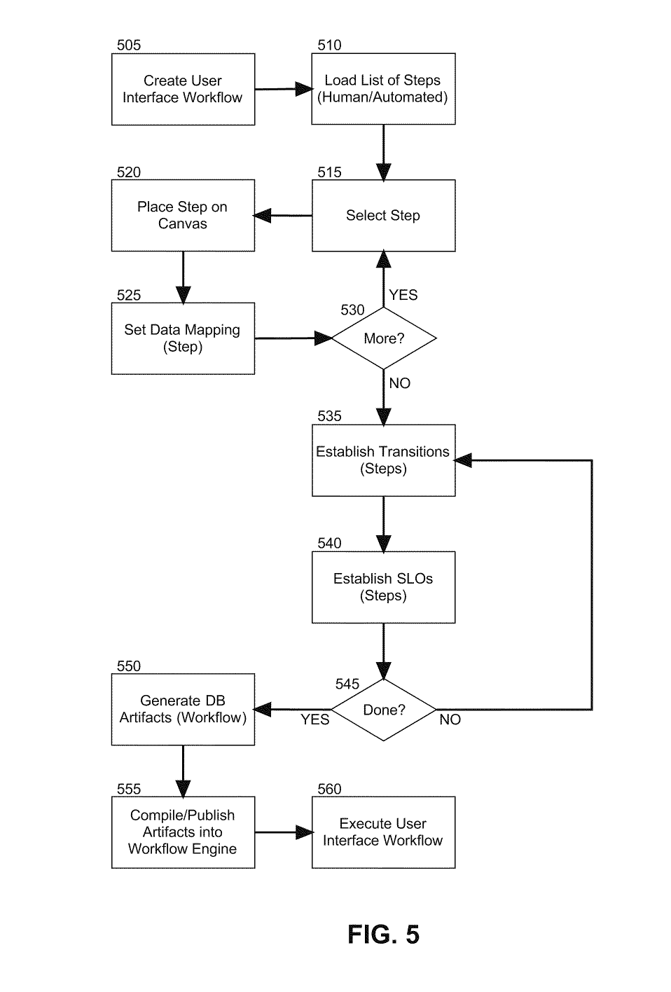

Finally, with reference to FIG. 5, a flow chart is shown to illustrate a process for user interface workflow composition. Beginning in block 505, a user interface workflow can be created in the composition tool user interface and a list of pre-defined steps, including both human steps and automated steps, can be loaded and rendered in a palette of the composition tool in block 510. In block 515, one of the pre-defined steps can be selected and placed onto the canvas of the composition tool in block 520. In block 525, the contextual data of the placed step can be configured through the composition tool by specifying contextual data used by the placed step and to be provided to the step by another step, and/or contextual data produced by the placed step for consumption by other steps. In decision block 530, if additional steps are to be placed onto the canvas, the process can repeat through block 515. Otherwise, the process can continue in block 535 with the establishment of transitions for each step placed in the canvas. Finally, in block 540 SLOs can be established for selected ones of the steps placed in the canvas.

In decision block 545, when all transitions and SLOs have been established as desired for the steps in the palette, in block 550 artifacts can be written to a database representative of the user interface workflow of the steps in the canvas, the defined transitions, the user interfaces for the human steps already defined for the human steps and the mappings of contextual data in the steps. Thereafter, in block 555, the artifacts of the database for the user interface workflow can be compiled into computer readable instructions and packaged for publication can be passed to a workflow engine for loading and execution in block 560. Consequently, end-to-end, a user interface workflow—a variable sequence of steps both human and automated and corresponding user interfaces for the human steps workflow for CRM—can be defined and deployed without requiring intervention by an end user or end users possessing software development expertise.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-readable medium providing program code for use by or in connection with a computer or any instruction execution system.

For the purposes of this description, a computer readable medium can be any apparatus that can contain, store, communicate, transport the program for use by or in connection with the instruction execution system, apparatus, or device. The medium can be an electronic, magnetic, electromagnetic, or semiconductor system (or apparatus or device). Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A user interface workflow composition method comprising:
defining a form of different fields, at least one of the fields in the form referencing a business object providing access to data in an external data source that is different than at least one other data source for a correspondingly different one of the fields;
loading into a composition module executing in memory by a processor of a computer from a data store coupled to the computer, a set of references to both human steps of a workflow, each of the human steps of the workflow referencing a corresponding user interface, and also automated steps of a workflow, each of the human steps and automated steps of the workflow individually comprising contextual data;
generating a human step for the defined form and loading the generated human step for the defined form into the composition module;
visually placing individual graphical elements each representative of a selected one of the human steps and automated steps into a canvas rendered by the composition module and also visually placing into the canvas an individual graphical element representative of the generated human step for the defined form;
defining transitions between different ones of the human steps and automated steps represented by corresponding ones of the graphical elements in the canvas by creating visual connections between the different ones of the graphical elements in the canvas, the human steps and automated steps represented by the graphical elements in the canvas, and the transitions defined therebetween setting forth a user interface workflow; and,
generating computer readable instructions for the user interface workflow.

2. The method of claim 1, further comprising providing the computer readable instructions to a workflow engine to generate programmatic objects implementing the user interface workflow including display of an instance of the defined form, and to execute the programmatic objects for use by end users over a computer communications network.

3. The method of claim 2, further comprising searching each field of the instance of the defined form for a matching string without searching a data source for each field in the instance of the defined form.

4. The method of claim 2, further comprising:
completing the different fields of the instance of the defined form; and,
persisting data for the completed different fields in correspondingly different external data sources through respective business objects.

5. The method of claim 2, further comprising:
retrieving data in different fields of the instance of the defined form from correspondingly different data sources external to the instance of the defined form;
persisting the retrieved data in an index separate from the different data sources external to the instance of the defined form; and,
processing queries against the index for data retrieved from the different data sources without searching the external data sources.

6. A workflow composition data processing system configured for user interface workflow composition, the system comprising:
a computer with processor and memory configured for communicative coupling to a workflow engine over a computer communications network:
a data store of pre-defined steps, comprising both human steps and automated steps, and screens corresponding to the pre-defined human steps;
a composition module executing in the memory by the processor of the computer, the module comprising computer program instructions enabled,
to define a form of different fields, at least one of the fields in the form referencing a business object providing access to data in an external data source that is different than at least one other data source for a correspondingly different one of the fields,
to load a set of references to both human steps of a workflow, each of the human steps of the workflow referencing a corresponding user interface, and also automated steps of a workflow, each of the human steps and automated steps of the workflow individually comprising contextual data,
to generate a human step for the defined form and loading the generated human step for the defined form into the composition module,
to visually place individual graphical elements each representative of a selected one of the human steps and automated steps into a canvas and also visually placing into the canvas an individual graphical element representative of the generated human step for the defined form,
to define transitions between different ones of the human steps and automated steps represented by corresponding ones of the graphical elements in the canvas by creating visual connections between the different ones of the graphical elements in the canvas, the human steps and automated steps represented by the graphical elements in the canvas, and the transitions defined therebetween setting forth a user interface workflow, and
to generate computer readable instructions for the user interface workflow.

7. The system of claim 6, further comprising a search module executing in the memory by the processor of the computer, the search module comprising program code enabled to search each field of an instance of the form for a matching string without searching a data source for each field in the instance of the defined form.

8. The system of claim 6, further comprising an index of content retrieved for different fields of an instance of the defined form from corresponding data sources external to the instance of the defined form for use in processing queries against the index for data retrieved from the different data sources without searching the external data sources.

9. A computer program product comprising a non-transitory computer readable medium embodying computer usable program code for user interface workflow composition, the computer program product comprising:
computer usable program code for defining a form of different fields, at least one of the fields in the form referencing a business object providing access to data in an external data source that is different than at least one other data source for a correspondingly different one of the fields;
computer usable program code for loading a set of references to both human steps of a workflow, each of the human steps of the workflow referencing a corresponding user interface, and also automated steps of a workflow, each of the human steps and automated steps of the workflow individually comprising contextual data;
computer usable program code for generating a human step for the defined form and loading the generated human step for the defined form into the composition module;
computer usable program code for visually placing individual graphical elements each representative of a selected one of the human steps and automated steps into a canvas rendered by the composition module and also visually placing into the canvas an individual graphical element representative of the generated human step for the defined form;
computer usable program code for defining transitions between different ones of the human steps and automated steps represented by corresponding ones of the graphical elements in the canvas by creating visual connections between the different ones of the graphical elements in the canvas, the human steps and automated steps represented by the graphical elements in the canvas, and the transitions defined therebetween setting forth a user interface workflow; and,
computer usable program code for generating computer readable instructions for the user interface workflow.

10. The computer program product of claim 9, further comprising computer usable program code for providing the computer readable instructions to a workflow engine to generate programmatic objects implementing the user interface workflow including display of an instance of the defined form, and to execute the programmatic objects for use by end users over a computer communications network.

11. The computer program product of claim 10, further comprising computer usable program code for searching each field of the instance of the defined form for a matching string without searching a data source for each field in the instance of the defined form.

12. The computer program product of claim 10, further comprising:
computer usable program code for completing the different fields of the instance of the defined form; and,
computer usable program code for persisting data for the completed different fields in correspondingly different external data sources through respective business objects.

13. The computer program product of claim 10, further comprising:
computer usable program code for retrieving data in different fields of the instance of the defined form from correspondingly different data sources external to the instance of the defined form;
computer usable program code for persisting the retrieved data in an index separate from the different data sources external to the instance of the defined form; and,
computer usable program code for processing queries against the index for data retrieved from the different data sources without searching the external data sources.
